(19) United States
(12) Patent Application Publication
(10) Pub. No.: US 2015/0268062 A1
(43) Pub. Date: Sep. 24, 2015

(54) DETECTING A SELECTED MODE OF HOUSEHOLD USE

(71) Applicant: Onzo Limited, London (GB)

(72) Inventors: Hoi Yu TANG, London (GB); Katie RUSSELL, Reading (GB)

(21) Appl. No.: 14/661,864

(22) Filed: Mar. 18, 2015

(30) Foreign Application Priority Data
Mar. 18, 2014 (GB) 1404856.5

(51) Int. Cl. G01D 4/02; G06N 7/00

(52) U.S. Cl. CPC G01D 4/02; G06N 7/005

(57) ABSTRACT

A system for detecting a selected mode of household use is provided. The system comprises a receiver for receiving utility usage data of the household over an observation period, and a processor. The processor is arranged to perform the steps of: dividing the data into time periods; for each time period, extracting at least one statistical value from the data; using the statistical values to separate the time periods into groups; and recognising among the groups a group associated with the selected mode by checking that utility usage of the group conforms to an expectation of the selected mode.

### FIELD OF THE INVENTION

This invention relates to systems, methods, devices and computer code for detecting a selected mode of household use based on utility usage data. For example, the invention is suited to using electricity usage data to detect whether a household is in an occupied or unoccupied condition.

### BACKGROUND

There is a significant transition in utility consumption between periods when a household is occupied and unoccupied. Occupied days, for example, may involve the residents being at home during the day, such as on weekend days, or being at home in the mornings and evenings but away during working hours. Unoccupied days, or ‘vacation days’, involve the residents being away for the whole day, for example being on holiday. For days when a household is unoccupied, utility consumption is typically markedly lower than on days when the household is occupied including working days (where the household has been unoccupied for a portion of day). However, the reduction in utility consumption associated with vacation days differs greatly between the seasons and between different households. For example, a large household with a high electricity baseload when occupied is likely to exhibit a significantly larger reduction in electricity consumption when it is vacated than a small household that uses less electricity in general when occupied.

Various techniques are known for using utility usage data to detect whether a household is occupied or unoccupied. These are typically focused on detecting a simple reduction in energy usage to indicate that the household has been vacated. However, this approach does not account for the differences in the magnitude of the reduction between seasons and households. This approach also fails to differentiate between vacation and behavioural changes, and between utility usage patterns for different family groups, house sizes and house location.

It is accordingly an object of the invention to provide an improved technique for detecting whether a household is occupied or unoccupied.

### SUMMARY OF THE INVENTION

The present inventors have found that it is possible to identify reliably different modes of household use, such as occupied and unoccupied use, by analysing utility usage data.

For instance, vacation of a household is typically associated with lower energy consumption and a more stable, i.e. more narrowly varying, trace of power through time. By contrast, occupied periods are typically associated with higher and more widely varying energy consumption. Furthermore, households typically spend more time in an occupied condition than in an unoccupied condition. These characteristics of occupied and unoccupied use of a household can be used to determine typical occupied and unoccupied energy usage for a given household, and to infer the days on which the household was vacated.

Accordingly, in a first aspect the invention provides a system for detecting a selected mode of household use, the system comprising: a receiver for receiving utility usage data of the household over an observation period; a processor arranged to perform the steps of: dividing the data into time periods; for each time period, extracting at least one statistical value from the data; using the statistical values to separate the time periods into groups; and recognising among the groups a group associated with the selected mode by checking that utility usage of the group conforms to an expectation of the selected mode.

Optionally, the system comprises a sensor for generating the utility usage data.

Optionally, the observation period is at least a plurality of months.

Optionally, the time periods are equal.

Optionally, the time periods are days.

Optionally, the processor is arranged to normalise the data.

Optionally, the processor is arranged to interpolate the utility usage data onto a predetermined time base.

Optionally, the processor is arranged to interpolate the utility usage data onto a predetermined time base using data from adjacent days to avoid edge nulls.

Optionally, the predetermined time base is 1 sec.

Optionally, the predetermined time base is 30 min.

Optionally, the processor is arranged to remove a baseload from the data.

Optionally, the processor is arranged to separate the time periods into groups by using mixture modelling.

Optionally, the processor is arranged to separate the time periods into groups by using Gaussian mixture modelling.

Optionally, separating the time periods into groups comprises determining an optimal number of groups.

Optionally, the processor is arranged to determine an optimal number of groups by using an information criterion.

Optionally, the information criterion is the Bayesian information criterion.

Optionally, the information criterion is the Akaike information criterion.

Optionally, the at least one summary statistic is mean rate of utility consumption.

Optionally, the at least one summary statistic is variance in rate of utility consumption.

Optionally, the at least one summary statistic comprises two statistical variables.

Optionally, the two statistical variables are mean rate of utility consumption and variance in rate of utility consumption.

Optionally, the processor is arranged to plot a function of one of the statistical variables against a function of the other statistical variable.

Optionally, the processor is arranged to plot the logarithm of the mean rate of utility consumption against the logarithm of the variance in rate of utility consumption.

Optionally, detecting a selected mode comprises detecting an occupied mode.

Optionally, the expectation comprises that the occupied mode is exhibited for more than a predetermined percentage of the observation period.

Optionally, the expectation comprises that the occupied mode is associated with utility usage of at least a predetermined level of stability.

Optionally, the predetermined level of stability is indicated by a cluster of plotted observation points having a median Mahalanobis distance less than a predetermined threshold.

Optionally, the processor is arranged to detect a plurality of occupied modes.

Optionally, detecting a selected mode comprises detecting a vacation mode.

Optionally, the expectation comprises that the vacation mode is associated with lower utility consumption than when the household is occupied.

Optionally, the lower utility consumption is indicated by a plotted observation point having a vector from the origin less than a resultant vector of a cluster of plotted observation points associated with an occupied mode.

Optionally, the utility is electricity, gas, water or any combination thereof.

In a second aspect the invention provides a method of detecting a selected mode of household use, the method comprising: receiving utility usage data of the household over an observation period; converting the data into units of rate of utility consumption if necessary; dividing the data into time periods; for each time period, extracting at least one summary statistic from the data; using the statistical values to separate the time periods into groups; and recognising among the groups a group associated with the selected mode by checking that utility usage of the group conforms to an expectation of the selected mode.

Optionally, the method comprises sensing utility usage and generating the utility usage data.

Optionally, the observation period is at least a plurality of months.

Optionally, the time periods are equal.

Optionally, the time periods are days.

Optionally, the method comprises normalising the data.

Optionally, the method comprises interpolating the utility usage data onto a predetermined time base.

Optionally, the method comprises interpolating the utility usage data onto a predetermined time base using data from adjacent days to avoid edge nulls.

Optionally, the predetermined time base is 1 sec.

Optionally, the predetermined time base is 30 min.

Optionally, the method comprises removing a baseload from the data.

Optionally, separating the time periods into groups comprises using mixture modelling.

Optionally, separating the time periods into groups comprises Gaussian mixture modelling.

Optionally, separating the time periods into groups comprises determining an optimal number of groups.

Optionally, determining an optimal number of groups comprises using an information criterion.

Optionally, the information criterion is the Bayesian information criterion.

Optionally, the information criterion is the Akaike information criterion.

Optionally, the at least one summary statistic is mean rate of utility consumption.

Optionally, the at least one summary statistic is variance in rate of utility consumption.

Optionally, the at least one summary statistic comprises two statistical variables.

Optionally, the two statistical variables are mean rate of utility consumption and variance in rate of utility consumption.

Optionally, the method comprises plotting a function of one of the statistical variables against a function of the other statistical variable.

Optionally, the method comprises plotting the logarithm of the mean rate of utility consumption against the logarithm of the variance in rate of utility consumption.

Optionally, detecting a selected mode comprises detecting an occupied mode.

Optionally, the expectation comprises that the occupied mode is exhibited for more than a predetermined percentage of the observation period.

Optionally, the expectation comprises that the occupied mode is associated with utility usage of at least a predetermined level of stability.

Optionally, the predetermined level of stability is indicated by a cluster of plotted observation points having a median Mahalanobis distance less than a predetermined threshold.

Optionally, the method comprises detecting a plurality of occupied modes.

Optionally, detecting a selected mode comprises detecting a vacation mode.

Optionally, the expectation comprises that the vacation mode is associated with lower utility consumption than when the household is occupied.

Optionally, the lower utility consumption is indicated by a plotted observation point having a vector from the origin less than a resultant vector of a cluster of plotted observation points associated with an occupied mode.

Optionally, the utility is electricity, gas, water or any combination thereof.

In a third aspect the invention provides computer program code which when run on a computer causes the computer to perform a method according to the second aspect.

In a fourth aspect the invention provides a carrier medium carrying computer readable code which when run on a computer causes the computer to perform a method according to the second aspect.

In a fifth aspect the invention provides a computer program product comprising computer readable code according to the third aspect.

In a sixth aspect the invention provides an integrated circuit configured to perform a method according to the second aspect.

In a seventh aspect the invention provides an article of manufacture for detecting a selected mode of household use, the article comprising: a machine-readable storage medium; and executable program instructions embodied in the machine readable storage medium that when executed by a programmable system causes the system to perform a method according to the second aspect.

In an eighth aspect the invention provides a device for detecting a selected mode of household use, the device comprising: a machine-readable storage medium; and executable program instructions embodied in the machine readable storage medium that when executed by a programmable system causes the system to perform a method according to the second aspect.

The invention further provides systems, devices, computer-implemented apparatus and articles of manufacture for implementing any of the aforementioned aspects of the invention; computer program code configured to perform the steps according to any one of the aforementioned methods; a computer program product carrying program code configured to perform the steps according to any one of the aforementioned methods; and a computer readable medium carrying the computer program.

### BRIEF DESCRIPTION OF THE DRAWINGS

The invention will now be described in detail with reference to the following drawings of which:

FIG. 1 is a flowchart illustrating data capture and analysis steps of a method of detecting household vacation according to an embodiment of the invention;

FIG. 2 is a flowchart illustrating details of the step of initialising data in the method of FIG. 1;

FIG. 3 is a flowchart illustrating details of the step of identifying clusters in the method of FIG. 1;

FIG. 4 is a flowchart illustrating details of the step of classifying clusters and observation points in the method of FIG. 1;

FIG. 5 is a power trace of a household illustrating power consumption for a period of over a year;

FIG. 6 is a scatter diagram summarising energy data of FIG. 5 in which each point in the scatter summarises energy usage on a particular day;

FIG. 7 is a reproduction of the scatter diagram of FIG. 6 showing an indication of the Mahalanobis distance of each observation point;

FIG. 8 is a functional block diagram of a vacation detection device according to an embodiment of the invention; and

FIG. 9 is a functional block diagram of a vacation detection device in communication with a server which performs data processing for the vacation detection device in accordance with a further embodiment of the invention.

### DETAILED DESCRIPTION OF THE INVENTION

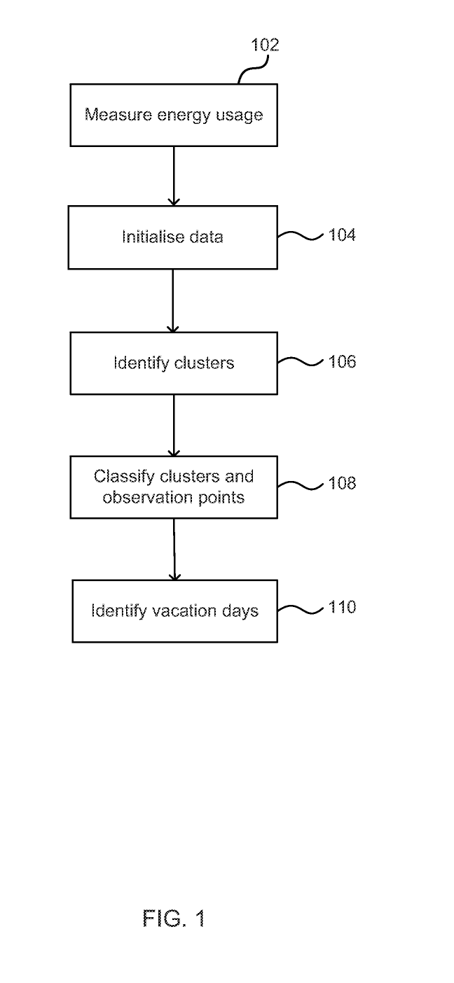

A method of detecting vacation days of a household according to an embodiment of the invention is illustrated in FIG. 1. Energy usage data is measured at step 102 by a sensing device which generates a stream of energy data of predetermined time resolutions. The time resolution may be selected from a range of periods including hourly readings and periods of 1 second or less. A higher frequency of measurement will yield more data which in turn will increase the accuracy of the statistics to be generated subsequently for summarising energy utilisation of observed days. In the description that follows it will be assumed that energy measurements are taken at a frequency of 1 Hz such that every second the sensor measures the energy consumed by the household in the preceding second and records it. This is a suitable frequency of measurement for generating accurate statistics for summarising days. Summary statistics representing each of the days may then be used to differentiate between days on which the household was occupied and days on which it was vacated.

Raw data from the sensor is initialised at step 104 for subsequent display in the form of a scatter diagram in which each point on the scatter represents an observed day. The location of the observation point on the scatter is determined by the statistics summarising the energy usage that was observed on that day, and the scatter illustrates how the daily energy usage statistics can be used to differentiate between occupied days and vacation days. Various patterns of energy consumption behaviour are associated with whether a household is occupied or vacated, and for a given day this behaviour will be reflected in the summary statistics for that day. As a result, days associated with different behaviours naturally separate out into groups or ‘clusters’ on the scatter diagram which are identified at step 106. For example, one cluster may be associated with the summer time occupied behaviour of a household, while another may be associated with household vacation. At step 108 the clusters are classified according to their associated behaviours (summer occupied, vacation, and so on), and certain observation points on the scatter are classified as representing vacation days. The steps of initialising the data, identifying clusters, and classifying clusters and observation points will be described further below. Finally, following the classification of observation points, the vacation days are identified at step 110.

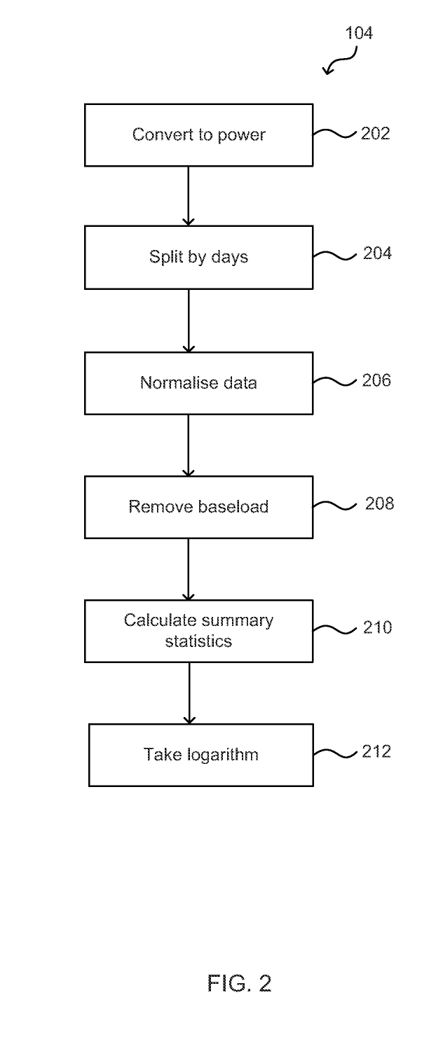

The initialising of the data will now be described with reference to FIG. 2. Before summary statistics can be extracted, the raw data is converted into power data (step 202) and split by days (step 204). The power data for each day is then normalised (step 206) by interpolating it onto a predetermined time base such as a 1 sec time base. For an accurate interpolation, data from adjacent days may be used to avoid edge nulls. If a 1 sec time base is used, the data in this embodiment would not require interpolation as measurements were taken at a frequency of 1 Hz. However, if the frequency of measurement is different to the predetermined time base, an interpolation step will be necessary here. At this stage, the data will be in the form of a normalised power stream split by days. Visualising this, there will be some days where the power stream takes higher values, and other days—typically those associated with vacation—where the power stream takes lower values. However, even on the lower days there will be a minimum power usage of the household to keep essential functions running. For example, to keep the temperature at least above zero during winter vacation days to avoid water in pipes freezing. Depending on the behaviours and lifestyle of the household, the level of this minimum power usage will vary based on how many permanently ON appliances (appliances which are plugged in and run autonomously) are present in the household, the size of the household, the quality and extent of heat insulation of the household, and so on. However, for a particular household there will generally be a minimum baseload usage that is always utilised regardless of whether the household is occupied or not. Since this baseload does not help to differentiate between vacation and occupied days, it can be removed from the data at step 208. Moreover, removing the baseload increases the relative variation of the power trace between occupied and unoccupied days which tightens up the clusters (described below) and improves the accuracy with which vacation days can be recognised. The baseload may be removed from the data on a daily basis—i.e. for each day, the baseload for that day is calculated and removed. Since the baseload varies with the season, this has the advantage of removing at least part of the seasonal variation in the data.

The next stage is to convert the power stream into a set of observation points that represent each of the observed days. To achieve this, mean power and variance are calculated for each day (step 210), and the inventors have found that these variables enable the observed days to be distinguished from one another and separated into groups corresponding to different household behaviours. For example, this approach enables vacation days to be differentiated from occupied days purely based on the summary statistics for each day. Rather than using the mean and variance values directly, logarithms of these values may be taken at step 212 and plotted on a scatter diagram. On such a diagram, the days corresponding to different energy consumption behaviours separate out into vacation and occupied clusters. By plotting the logarithm of mean power against the logarithm of variance in power, rather than just mean power against variance in power, the clusters are advantageously scale-invariant. This means that the size and relative spacing of the clusters does not depend on the units of power that were used. For example, consider a first case in which power units of Watts (W) are used and a second case in which power units of kiloWatts (kW) are used. Since 1 kW is equal to 1000 W, there is a factor difference of 1000. In log space this difference is additive not multiplicative—i.e. log(1000X)=log(X)+log(1000). As a result, the only effect of the different power units in log space is to shift (i.e. translate) the clusters on the scatter diagram, but their size and shape is not affected. This means that various properties of the clusters, such as the mean Mahalanobis distance which is described below, are unaffected by the choice of units in which power is measured.

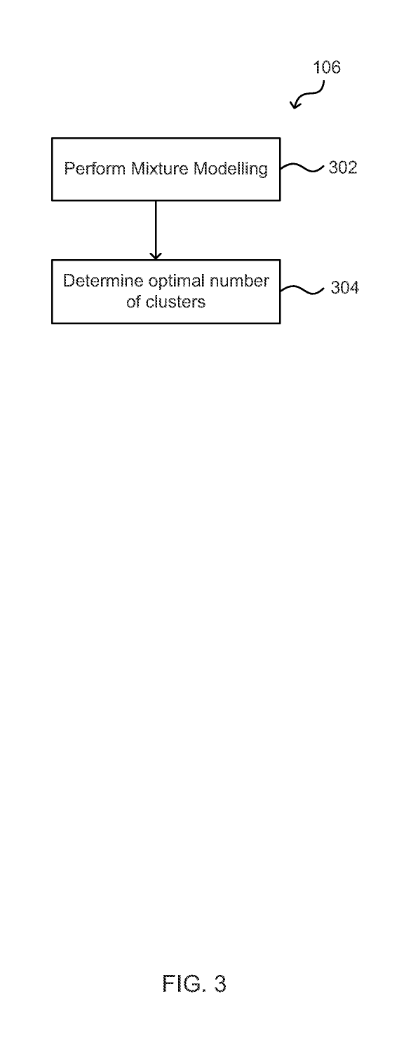

The clusters can be modelled using various techniques. For example, in a suitable approach, mixture modelling can be performed on the data set as shown in FIG. 3 (step 302). In this approach, it is common to apply the mixture modelling technique multiple times, each time assuming a different number of clusters (for example one, two, three and four), before deciding which version best represents the data. In order to decide which version is best, an information criterion may be used to determine the optimal number of clusters (step 304). For example, if there are three types of behaviour—summer occupied, winter occupied, and vacation—then the information criterion can be used to determine that an assumption that there are three clusters best models the data. This may not be immediately apparent from a scatter diagram if the two home clusters are overlapping and have close centres. In any case, at the end of this modelling process we have a set of observation points separated into an optimal number of discrete clusters.

The clusters must now be classified to establish which of them represent days when the household was occupied. There are two requirements for a cluster to be classified as a home cluster—i.e. as representing occupied days. Firstly, the cluster must include a minimum percentage of all the observed days. This requirement is based on the assumption that the household spends more days in an occupied condition than in a vacated condition. Secondly, the cluster must be sufficiently tight—i.e. the observation points belonging to the cluster must be sufficiently close together on the scatter diagram. This is based on the assumption that when the household is occupied energy consumption is predominantly consistent through time.

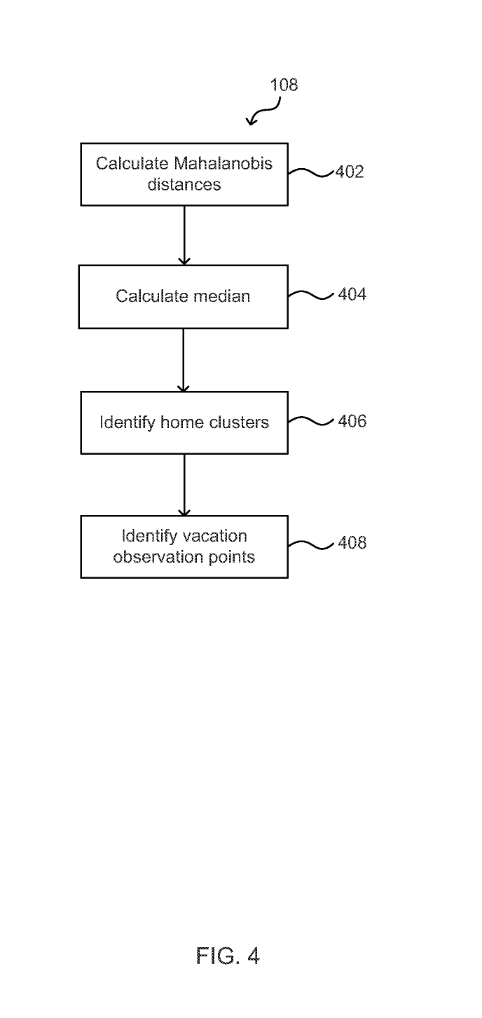

In order to quantify the requirement that home clusters are sufficiently tight, a metric is used to describe how spread out the observation points are. This is the median Mahalanobis distance, and the smaller the value the tighter the cluster. With reference to FIG. 4, the distance on the scatter between each observation point and the inferred centre of the cluster is calculated (step 402). These individual Mahalanobis distances are ranked and the median Mahalanobis distance for the whole cluster is then calculated (step 404). If the median value is less than a predetermined maximum, the cluster satisfies the requirement. If the cluster also satisfies the requirement that it contains at least a predetermined minimum percentage of all the observed days, the cluster is classified as being a home cluster. This process is repeated for all the clusters so that all the home clusters can be identified (step 406).

As described above, the log space makes the Mahalanobis distance scale-invariant, resulting in a translation in the feature space that does not affect the Mahalanobis distance. In general, the properties of the Mahalanobis distance mean that it is invariant under a translation or rotation of the feature space.

Once the home clusters have been identified, the final classification step is to identify the observation points representing vacation of the household. Each of the observation points not belonging to a home cluster is a potential candidate. For each of these points, the magnitude of a vector from the origin of the scatter to that point is calculated. If this is less than the magnitude of the resultant vector of the home cluster with the largest resultant vector in log(mean)-log(variance) power space, then the observation point is identified as representing a vacation day (step 408). This approach is based on the expectation that energy usage is lower on vacation days than on occupied days.

When the steps of FIG. 4 are complete, the vacation observation points that have been identified can be matched up with the days they represent to infer the days on which the household was vacant. This completes the algorithm for determining days of vacation.

The algorithm identifies vacation days based on observing the patterns of energy consumption behaviour exhibited by the household, and as a result provides a method of recognising vacation days that is tailored to the household in question. As the observation period increases the amount of data available for building an energy usage profile for the household increases, and the accuracy with which the algorithm can recognise vacation days improves. For example, a suitable level of reliability can be achieved using data collected over a period in the region of months. Collecting data over a period of this length ensures that the clusters are accurately defined and that the occupants of the household do in fact go on vacation so that some vacation days can be identified.

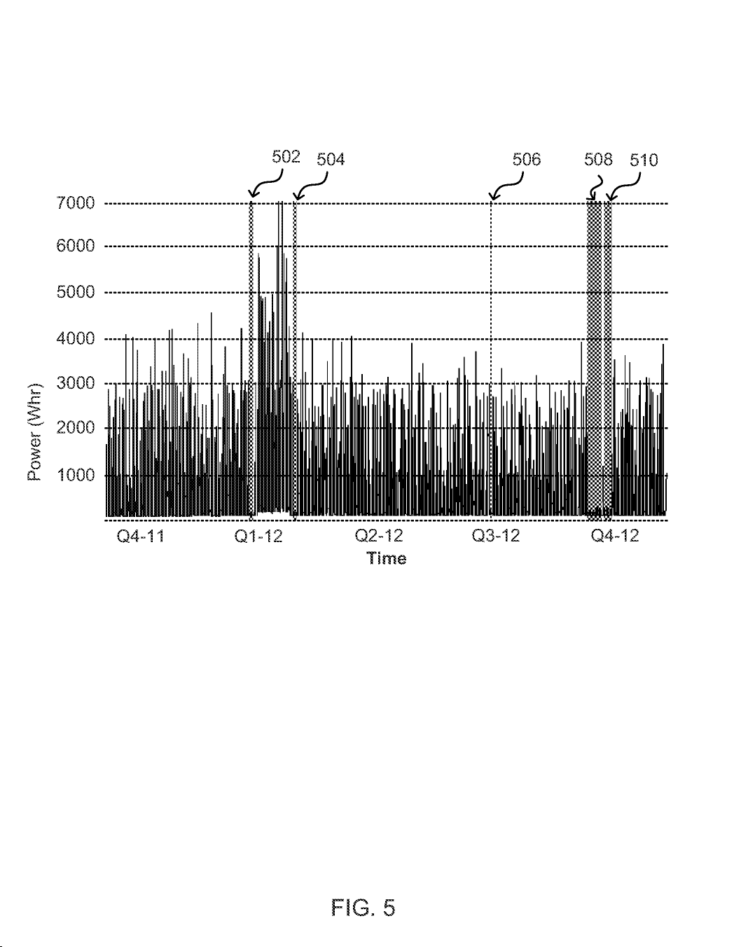

Referring to FIG. 5, there is shown a power trace over a period of over a year for a household.

On the horizontal axis is time marked with intervals of annual quarters (e.g. ‘Q4-11’ refers to the fourth quarter of 2011). The vertical axis is mean daily power consumption in units of Watt-hours. The above-described method has been used to identify vacation days for this data, and groups of these days are indicated on the trace by arrows 502, 504, 506, 508 and 510.

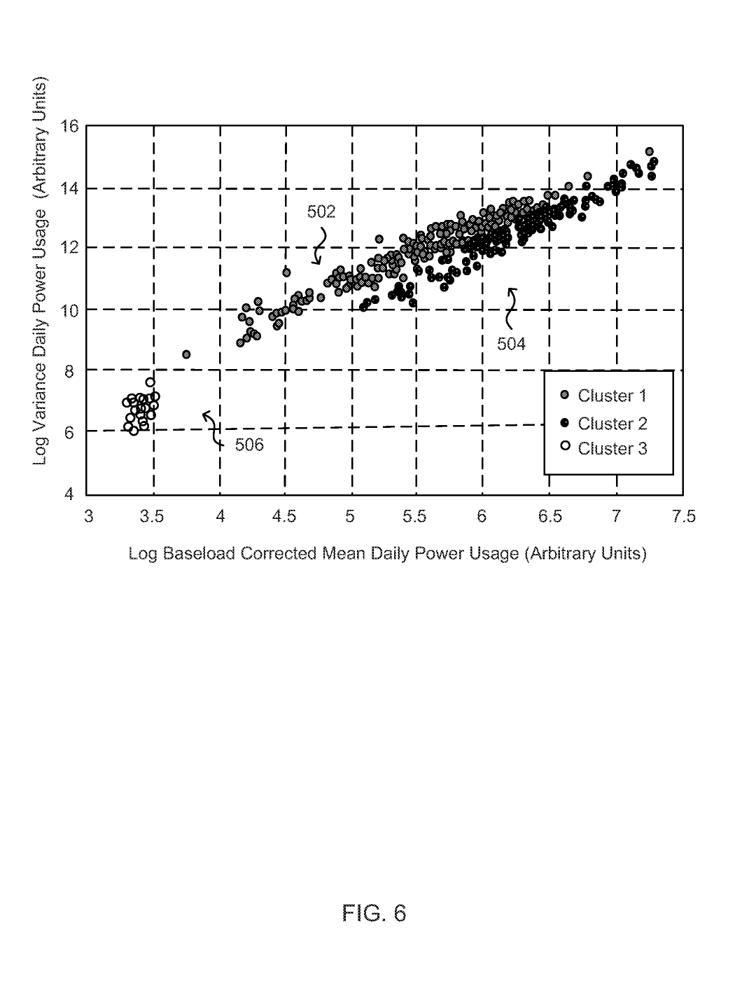

A scatter diagram derived from this power trace is shown in FIG. 6. The logarithm of the variance in daily power usage (vertical axis) is plotted against the logarithm of the baseload-adjusted mean daily power usage (horizontal axis). The axes are labelled ‘A.U.’ to indicate ‘arbitrary units’ since the variables (log mean and log variance) are unitless. In order to arrive at this scatter diagram from the power trace, Gaussian Mixture Modelling has been used because the data are Gaussian distributed, and the optimal number of clusters has been determined using the Bayesian information criterion. In other examples an alternative information criterion may be used, such as the Akaike information criterion (AIC). As shown in FIG. 6, three clusters emerge from the data set. There is a clear vacation cluster 506 located in the lower left of the log(mean)-log(variance) power space. In the upper-right of the scatter diagram there are two home clusters, 502 and 504, which may for example represent summer and winter behaviour. This would be a reasonable interpretation because the home clusters are relatively close together and the difference between summer and winter power usage is less than the difference between occupied and vacated power usage. In this interpretation, it would be appropriate to interpret the home cluster 504 on the right hand side as being the winter cluster in a Northern country because it is associated with higher daily power usage. The winter home cluster 504 appears as being similar to the summer home cluster 502, but shifted to the right. Conversely, in a hot location, such as a Mediterranean country or southern American state, the higher daily power usage would be associated with domestic air-conditioner and pool pump usage in the summer months.

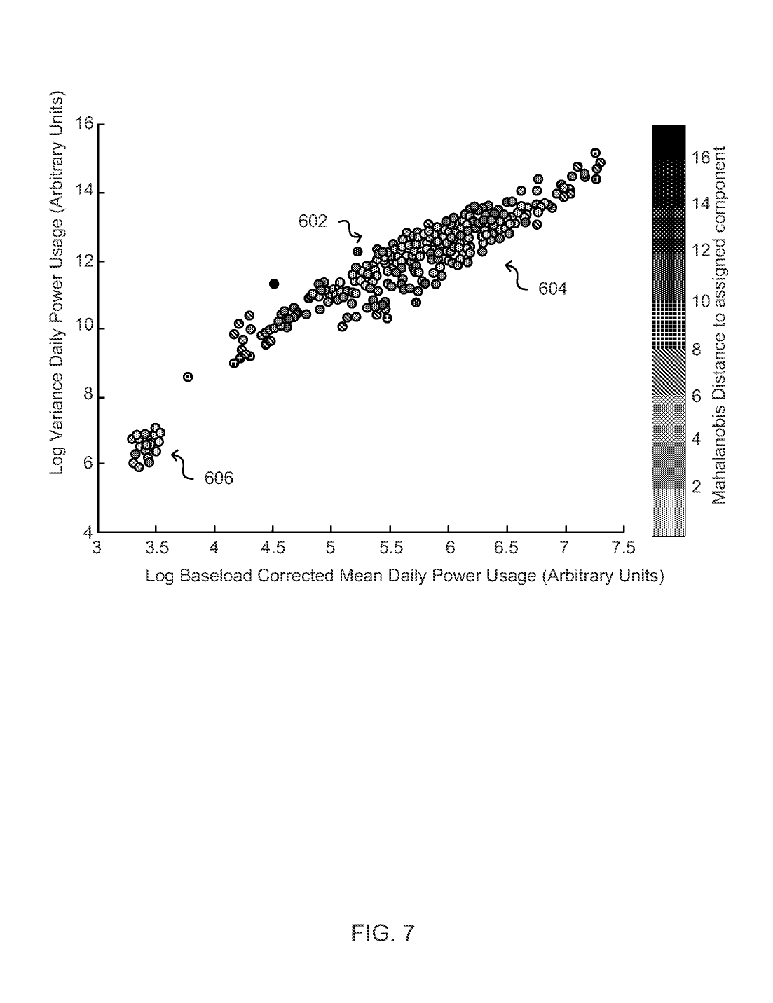

The same data are illustrated in the scatter diagram of FIG. 7. This diagram illustrates the Mahalanobis distance of each of the observation points. The Mahalanobis distance increases as the observation point moves further from its respective cluster centre.

Functions relating to vacation detection using energy usage data may be implemented on computers connected for data communication via the components of a packet data network. Although special purpose devices may be used, such devices also may be implemented using one or more hardware platforms intended to represent a general class of data processing device commonly used so as to implement the event identification functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. energy usage measurements for a time period already elapsed. The software code is executable by the general-purpose computer that functions as the server or terminal device used for vacation detection. In operation, the code is stored within the general-purpose computer platform. At other times, however, the software may be stored at other locations and/or transported for loading into the appropriate general-purpose computer system. Execution of such code by a processor of the computer platform or by a number of computer platforms enables the platform(s) to implement the methodology for vacation detection, in essentially the manner performed in the implementations discussed and illustrated herein.

Those skilled in the art will be familiar with the structure of general purpose computer hardware platforms. As will be appreciated, such a platform may be arranged to provide a computer with user interface elements, as may be used to implement a personal computer or other type of work station or terminal device. A general purpose computer hardware platform may also be arranged to provide a network or host computer platform, as may typically be used to implement a server.

For example, a server includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications.

A user terminal computer will include user interface elements for input and output, in addition to elements generally similar to those of the server computer, although the precise type, size, capacity, etc. of the respective elements will often different between server and client terminal computers. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of vacation detection outlined above may be embodied in programming. Program aspects of the technology may be thought of as “products” or “articles of manufacture” typically in the form of executable code and/or associated data that is carried on or embodied in a type of machine readable medium and/or in a plurality of such media. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the organisation providing vacation detection services into the vacation detection computer platform. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the vacation detection, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

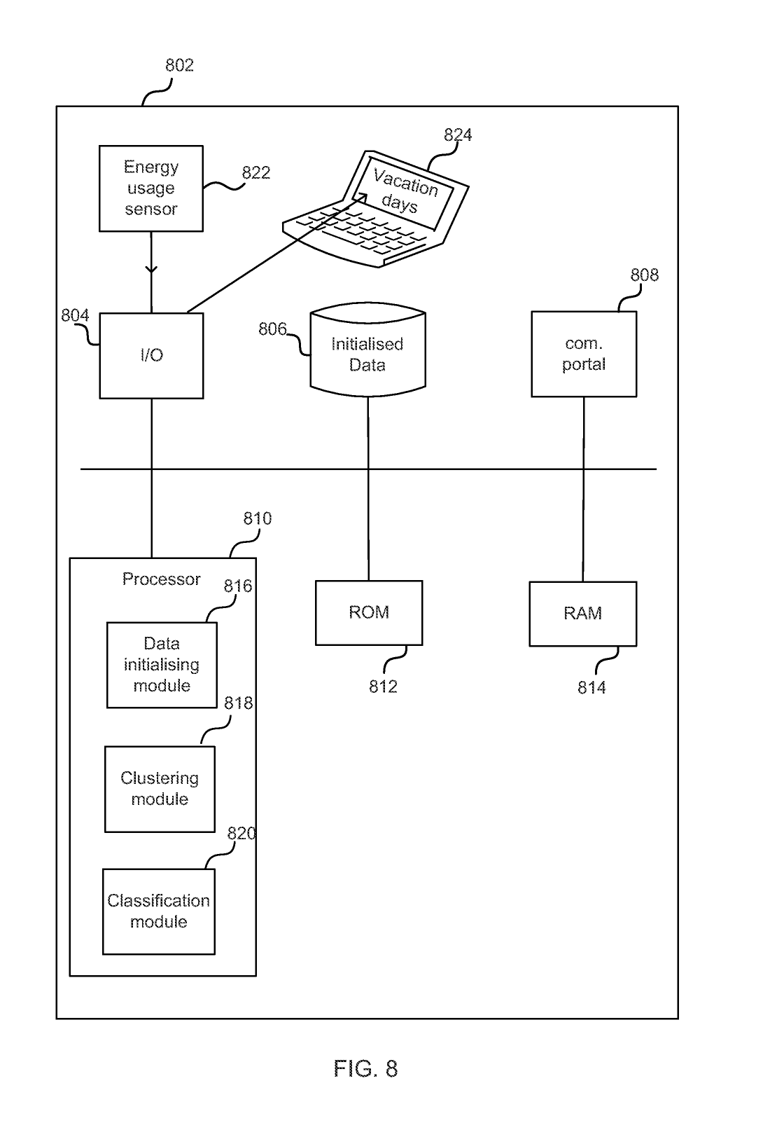

Referring to FIG. 8, a special purpose vacation detection device 802 is shown. The device 802 comprises an input and output interface element 804, a database 806 for storing initialised data, a communications portal 808, a processor 810, ROM 912 and RAM 814. The processor includes a data initialising module 816 for carrying out the step 104 of initialising energy usage data, a clustering module 818 for carrying out the step 106 of identifying clusters, and a classification module 820 for carrying out the step 108 of classifying clusters and observation points. The interface element 804 is arranged to receive energy usage data from an energy usage sensor 822 and to output identified vacation days to a display screen 824. The energy usage sensor 822 could for example be provided as a current transformer which wirelessly transmits its data, or for example as a smart meter, as are known in the art.

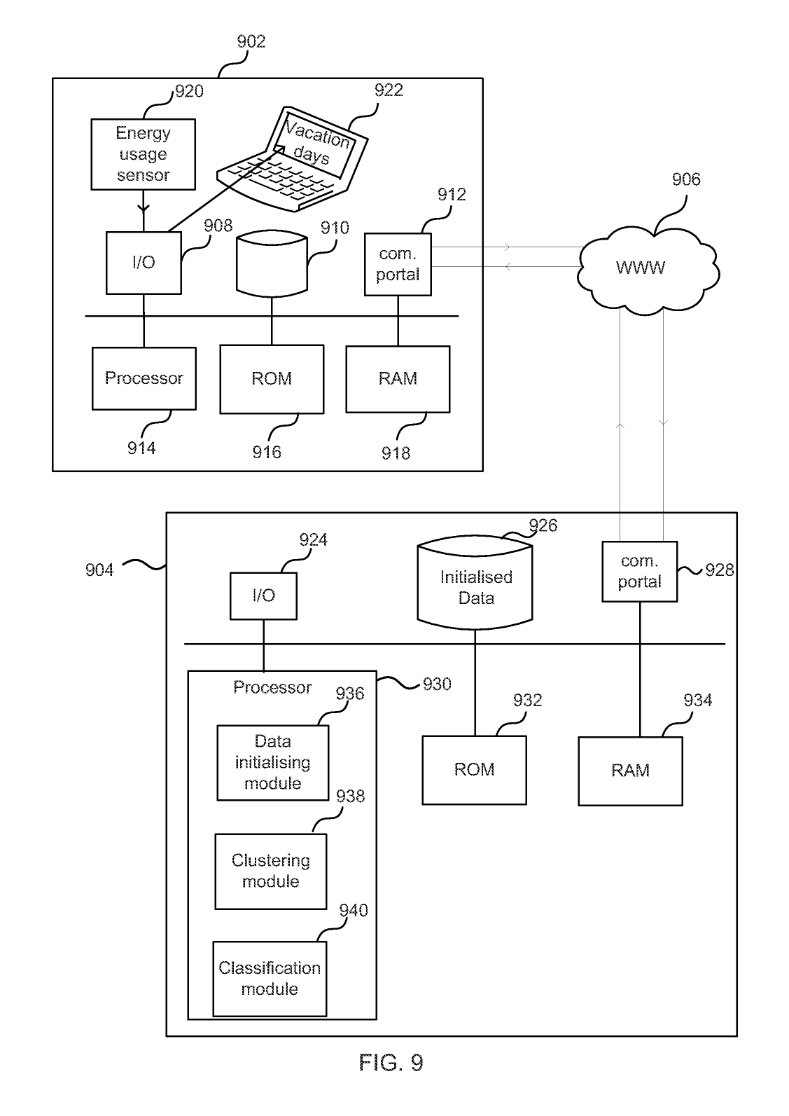

In FIG. 9, an alternative arrangement is shown in which the vacation detection functionality of the invention is implemented using a user terminal 902 in communication with a vacation detection server 904. This arrangement shifts the processing burden to the server 904, which may be located remotely, for example at the utility provider. The user terminal 902 comprises an input and output interface element 908, a database 910, a communications portal 912, a processor 914, ROM 916, and RAM 918. The interface element 908 is arranged to receive energy usage data from an energy usage sensor 920 and to output identified vacation days to a display screen 922. The communications portal 912 of the user terminal 902 is in communication with the server 904 via the Internet 906 so that energy usage data can be sent to the server 904 for processing.

At the server 904 there is an input and output interface element 924, a database 926 for storing initialised data, a communications portal 928, a processor 930, ROM 932, and RAM 934. Since the processing of the energy usage data takes place at the server 904, the processor 930 includes a data initialising module 936 for carrying out the step 104 of initialising energy usage data, a clustering module 938 for carrying out the step 106 of identifying clusters, and a classification module 940 for carrying out the step 108 of classifying clusters and observation points. When vacation days have been identified at the server, these are communicated back to the user terminal 902 via the Internet 906 for being displayed to the user at the display screen 922. If the server 904 is located at the utility provider, the output of the server may alternatively be displayed at the utility provider which may process the data further before making it available to the household where the energy usage sensor 920 is located.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. A system for detecting a selected mode of household use, the system comprising:
a receiver for receiving utility usage data of the household over an observation period;
a processor arranged to perform the steps of:
dividing the data into time periods;
for each time period, extracting at least one statistical value from the data;
using the statistical values to separate the time periods into groups; and
recognising among the groups a group associated with the selected mode by checking that utility usage of the group conforms to an expectation of the selected mode.

2. The system of claim 1, comprising a sensor for generating the utility usage data.

3. The system of claim 1, wherein the observation period is at least a plurality of months.

4. (canceled)

5. (canceled)

6. The system of claim 1, wherein the processor is arranged to normalise the data.

7. (canceled)

8. The system of claim 1, wherein the processor is arranged to interpolate the utility usage data onto a predetermined time base using data from adjacent days to avoid edge nulls.

9. The system of claim 8, wherein the predetermined time base is one of 1 second and 30 minutes.

10. (canceled)

11. The system of claim 1, wherein the processor is arranged to remove a baseload from the data.

12. (canceled)

13. The system of claim 1, wherein the processor is arranged to separate the time periods into groups by using Gaussian mixture modelling.

14. The system of claim 1, wherein the processor is arranged to separate the time periods into groups by determining an optimal number of groups using one of a Bayesian information criterion and an Akaike information criterion.

15-29. (canceled)

30. The system of claim 1, wherein the processor is further arranged to detect a vacation mode, wherein the expectation comprises that the vacation mode is associated with lower utility consumption than when the household is occupied.

31. The system of claim 30, wherein the lower utility consumption is indicated by a plotted observation point having a vector from an origin less than a resultant vector of a cluster of plotted observation points associated with an occupied mode.

32. The system claim 1, wherein the utility is at least one of electricity, gas, and water.

33. A method of detecting a selected mode of household use, the method comprising:
receiving utility usage data of the household over an observation period;
dividing the data into time periods;
for each time period, extracting at least one summary statistic from the data;
using the statistical values to separate the time periods into groups; and
recognising among the groups a group associated with the selected mode by checking that utility usage of the group conforms to an expectation of the selected mode.

34-50. (canceled)

51. The method of claim 33, wherein the at least one summary statistic is variance in rate of utility consumption.

52. The method of claim 33, wherein the at least one summary statistic comprises mean rate of utility consumption and variance in rate of utility consumption.

53. (canceled)

54. (canceled)

55. The method of claim 52, further comprising plotting a logarithm of the mean rate of utility consumption against the logarithm of the variance in rate of utility consumption.

56-70. (canceled)

71. A computer program product comprising:
a machine readable storage medium; and
executable program instructions embodied in the machine readable storage medium configured to:
receive utility usage data of the household over an observation period;
divide the data into time periods;
extract at least one summary statistic from the data for each time period;
use the statistical values to separate the time periods into groups; and
recognise among the groups a group associated with the selected mode by checking that utility usage of the group conforms to an expectation of the selected mode.

72. The computer program product of claim 71, wherein the machine readable storage medium is further configured to detect an occupied mode, and wherein the expectation comprises that the occupied mode is exhibited for more than a predetermined percentage of the observation period.

73. The computer program product of claim 72, wherein the expectation comprises that the occupied mode is associated with utility usage of at least a predetermined level of stability, wherein the predetermined level of stability is indicated by a cluster of plotted observation points having a median Mahalanobis distance less than a predetermined threshold.

74. The computer program product of claim 71, wherein the processor is arranged to detect a plurality of occupied modes.
